(19) United States
(12) Patent Application Publication
(10) Pub. No.: US 2005/0255607 A1
(43) Pub. Date: Nov. 17, 2005

(54) Scent identification apparatus and method

(76) Inventors: Nicolas Vezard, Metuchen, NJ (US); Salvatore Atzeni, Edison, NJ (US)

Correspondence Address: ANTHONY H. HANDAL;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 10/843,053

(22) Filed: May 11, 2004

(51) Int. Cl. A01M 1/10

(52) U.S. Cl. 436/174; 422/83

(57) ABSTRACT

A scent collection method comprising putting an item bearing a sample of a scent to be identified in an enclosure and heating the item is disclosed. A quantity of air is introduced into the enclosure. The air from the enclosure is withdrawn after the item has been heated. The withdrawn air is passed through a scent collection member to collect scent on the scent collection member. The scent collection member may be cooled during the scent collection process and the scent collection member is then sealed in an envelope. The scent collection member is removed from the envelope in which the scent collection member has been sealed. The scent collection member is then heated and air passed through the scent collection member. The air passed through the scent collection member is used as a stimulus or other input in a scent identification procedure.

### TECHNICAL FIELD

The invention relates to systems, devices and methods for the efficient collection, storage, utilization and evaluation of scent samples particularly useful in forensic applications.

### CROSS REFERENCE TO RELATED APPLICATIONS

Not applicable.

### STATEMENT REGARDING FEDERALLY SPONSORED RESEARCH AND DEVELOPMENT

Not applicable.

### BACKGROUND OF THE INVENTION

Since antiquity, the olfactory precision and sensitivity of animals has been known. For almost as long, man has harnessed these capacities for a wide range of applications. Even today, there are no commercial instrumentation systems that can match the sensitivity of pigs trained to detect the subtle aromas of truffles hidden under earth, leaves and brush in the forest. Similarly, dogs trained to track or identify people, or to detect substances such as explosives and marijuana, remain the backbone of law enforcement in an age where instrumentation and computers dominate virtually all other areas of forensics.

Techniques have been substantially advanced from the classic situation where specially trained dogs smell a garment belonging to a runaway criminal, and the chase begins. Dogs have also been used in less frenetic applications, such as the detection of a lost child, and in various forensic comparative applications.

For example, trained dogs may be used to identify suspects in a scent lineup. A garment removed from a crime scene may be permeated with scent sufficient to identify individuals who were present at the crime scene. In such circumstances, detectives may collect garments, home furnishings, or the like and place them in plastic bags to preserve the scents which they carry for a later detection process.

Generally, techniques may be classified as 1) scent detection techniques which involve the provision of a stimulus comprising a scent sample to an animal which is trained to seek and identify another source of the scent, and 2) scent identification techniques involving the presentation of an objective known scent as a primary stimulus to an animal, followed by presentation of a plurality of unknown scents as secondary stimuli to the same animal to determine which of the unknown scents provokes an identification response. This latter procedure it is sometimes referred to as a “scent lineup”.

As alluded to above, recent years have seen the application of electronic instrumentation to scent identification problems. Electronic instrumentation offers the advantage of sensitivity to a wide range of materials including biologicals as well as other substances which may be dispersed by an individual, and/or the things about him, into his environment. Instrumentation outputs, as compared to the binary identity information provided by trained dogs, contain a wealth of information, both quantitative and qualitative. For example, a sample may be screened for a wide variety of materials, the detection of the materials indicated and the quantitative concentrations of such materials included in an output.

Over the years, scent concentration techniques have also been developed. For example, a small area of a gauze pad may be wiped over the entire surface of a hard object, such as a tabletop in an effort to collect scent deposited on the tabletop. The gauze pad is then put in envelope, for example one made of mylar, and the envelope with the gauze pad in it is sealed for later use. Thus, scent may be collected at a crime scene at a point in time when the scents are relatively freshly deposited and most plentiful, and used at a later point in time when scent has been collected from a suspect. In such circumstances, the scent collected from the suspect can be compared to the scent collected at the crime scene to determine whether the scents are the same. Such determination may be made using specially trained dogs.

Techniques are also available for the collection of scent from the air. Thus, if a crime has been detected relatively quickly after the time of its commission, an air pump may be used in a vacuum cleaner-like configuration to drive, for example, all of the air in a room through a collection pad made of gauze. Here again, after the collection process has been completed, the gauze pad, imbued with the scent in the room, is put in a sealed mylar bag for later use. It is noted that in accordance with the invention other means may be used to preserve a collector imbued with odiferous materials, including, in particular, a glass or plastic vial.

While these techniques work well, they do suffer from significant limitations. For example, preservation of a scent in a sealed envelope necessarily involves losses over time. Hence, the desirability of scent collection and concentration, as in the above example of a gauze pad being rubbed over a tabletop, or the alternative example of a vacuum cleaner-like device being used to collect a quantity of scent from the air in a room.

Another advantage of concentration techniques is that the process makes more viable the use of electronic instrumentation, such as a mass spectrograph. In the age of electronic instrumentation, results from such devices often have a greater degree of reliability. Certainly, their operation may be more easily understood and output results more intuitively grasped by a finder of fact in a judicial proceeding. Hence, there is a higher likelihood that a positive indication of identification will be accepted by a jury or a judge in a proceeding.

However, electronic detection systems are substantially less sensitive to odiferous agents as compared to animals. Accordingly, any system or method which results in concentrating a greater amount of scent improves the possibility of using electronic instrumentation. Likewise, such techniques improve the shelf life of scent samples in a scent bank. Finally, concentration of scents in a sample by more efficient collection also improves the possibility of a positive indication in a wider variety of circumstances, when using animals such as dogs to perform a scent detection or identification operation.

### SUMMARY OF THE INVENTION

In accordance with the invention a scent collection method comprises putting an item bearing a sample of a scent to be identified in an enclosure and heating the item. A quantity of air is introduced into the enclosure. The air from the enclosure is withdrawn after the item has been optionally heated. The withdrawn air is passed through a scent collection member to collect scent on the scent collection member. The scent collection member is cooled during the scent collection process and the scent collection member is then sealed in an envelope. The scent collection member is removed from the envelope in which the scent collection member has been sealed. The scent collection member is then heated and air passed through the scent collection member. The air passed through the scent collection member is used as a stimulus or other input in a scent identification procedure.

The procedure may comprise using electronic instrumentation or trained animals to obtain information respecting the collected scent. Heating of the item may be performed after the enclosure has been sealed, after an item of information has been uncovered relating to the sample.

An alternative method of collecting scent from a smooth surface for forensic evaluation, comprises wiping a scent collecting member over a portion of the smooth surface and enclosing the smooth surface in a scent-containing container containing air. The smooth surface is optionally heated with a sufficient degree of heat to release relatively volatile scent material into the air, while retaining less volatile material on the smooth surface. The air is driven through a collection member to collect in the collection member volatile scent material released into the air. The collection member may be cooled while driving the air through the collection member to collect in the collection member volatile scent material released into the air.

In accordance with the invention a scent collection apparatus comprises an enclosure for receiving an item bearing a sample of a scent to be identified, a first heater for increasing the temperature of the item, and an air blower having an output and having an input, the input being coupled to withdrawn air from the enclosure containing the item. A scent collection member is coupled to receive the output of the air blower, whereby odiferous materials entrained within the air output by the blower are caused to accumulate on the scent collection member. A cooling member may be thermally coupled to the scent collection member. A second heater may be coupled to the scent collection member. A second air blower may be coupled to drive air to the scent collection member. A conduit passes air passed through the scent collection member to an output port for use as a stimulus in a scent identification procedure. The scent collection member may comprise a zeolite, or activated charcoal.

The cooling member may comprise a Peltier cell. The first heater may comprise an electrochemical heat releasing cartridge. Alternatively, the cooling member comprises an electrochemical cooling cartridge. The second heater may comprise an electrical heater. The cooling member may also comprise a refrigerant based cooler.

In accordance the invention, it is also possible to collect scent from a sample using a vacuum, with or without the heating of the sample or cooling of the collector. The invention also provides for the output of scent from a collector using a vacuum with or without the heating of the collector.

### BRIEF DESCRIPTION OF THE DRAWINGS

The operation of the invention will become apparent from the following description taken in conjunction with the drawings, in which:

FIG. 1 is a perspective view of a scent collection member constructed in accordance with the present invention;

FIG. 2 is a cross-sectional view of the scent collection member of FIG. 2 a long lines 1-1 of FIG. 1;

FIG. 3 illustrates an alternative embodiment of a scent collection member constructed in accordance with the present invention and including a narrowed portion to facilitate cooling or heating of the same;

FIG. 4 is a cross-sectional view of the scent collection member of FIG. 3 along lines 4-4 of FIG. 3;

FIGS. 5 is a cross-sectional view similar to that of FIG. 4 showing the use of a Peltier cell to cool the same;

FIGS. 6 is a perspective view of a slotted bottle for cooling or heating the scent collection member constructed in accordance with the present invention;

FIG. 7 cross-sectional view similar to that of FIG. 5 but showing the use of a slotted bottle to achieve cooling or heating of a scent collection member;

FIG. 8 is a perspective view of an alternative slotted bottle;

FIG. 9 is a schematic view of a system for concentrating scent in a scent collector;

FIG. 10 is a schematic view of an alternative system for concentrating scent in a scent collector;

FIG. 11 is a schematic view of another alternative system for concentrating scent in a scent collector;

FIG. 12 is a schematic view of a system for outputting concentrated scent from a scent collector;

FIG. 13 is a flowchart illustrating a method of performing a forensic odiferous material identification in accordance with the present invention;

FIG. 14 is a flowchart illustrating an alternative method of performing a forensic odiferous material identification in accordance with the present invention;

FIG. 15 is a flowchart illustrating another method of performing a forensic odiferous material identification in accordance with the present invention; and

FIG. 16 is a schematic view of an alternative system for concentrating scent in a scent collector.

### DETAILED DESCRIPTION OF THE PREFERRED EMBODIMENTS

In accordance with the present invention, a collection cartridge 10 constructed of a tubular plastic member 12 is provided with an internal collection member 14 which may be made from a wide range of materials, such as packed fibrous material, for example cotton or polyester. In accordance with a preferred embodiment of the present invention, the material may be selected with desired surface characteristics. For example one may use a hydrophobic material or a hydrophilic material, depending upon the characteristics of the materials which one anticipates collecting.

In accordance with a preferred embodiment, collection member 14 is made of charcoal. Charcoal or acticated charcoal is particularly advantageous, as it is porous and the pores can absorb and retain large amounts of molecules. Collection member is baked and out gassed to ensure that the charcoal is free of any contaminating scents from handling, manufacturing, and so forth. The uncontaminated collection member is then packaged in a sealed bag, made, for example, of metalized plastic film, such as Mylar (R) plastic. The bag is opened just before it is to be used. This is especially critical in the event that crime scene air is to be used as a scent source.

Collection member 14 may also be of a non-fibrous nature, such as open cell foam plastic, particles, or any other material whose structure allows air to pass through it, such as a collection screen, wire mesh, or the like. All of the same may also be given desired hydrophilic or hydrophobic characteristics.

In accordance with one particularly preferred embodiment of the invention in which a collection cartridge 10 is cooled in order to maximize the amount of scent material collected, collection members 14, having a high specific heat or thermal capacity and thus the ability to absorb or release a large amount of heat, if cooled prior to a collection operation are particularly effective to collect material for analysis.

Sand, metal grindings, powdered glass and the like will also function, if pre-cooled, to effectively condense odiferous materials.

Charcoal and zeolites and other porous structures are particularly preferred collection materials in collection member 14.

If desired, the collection member 14 may be kept in place by a pair of support walls 16 and 18. Support walls 16 and 18 define holes 20, which provide for the passage of air containing odiferous materials. During use, air carrying various scents is caused to enter into an inlet port 22, pass through holes 20, and enter collection member 14. The odiferous materials are then caused to collect on the constituent fibers, particles, or the like of collection member 14. Air which has been stripped of odiferous materials then passes through holes 20 in support wall 16 and pass to output port 24.

When the collection operation has been completed, airtight plugs 26 and 28 may be inserted into ports 22 and 24 to lock in collected odiferous material. In accordance with a preferred embodiment of the invention, this sealing operation would be made further effective by putting the plugged collector 10 in a plastic bag (for example a metalized plastic bag), and then sealing the bag and removing all excess air from the bag.

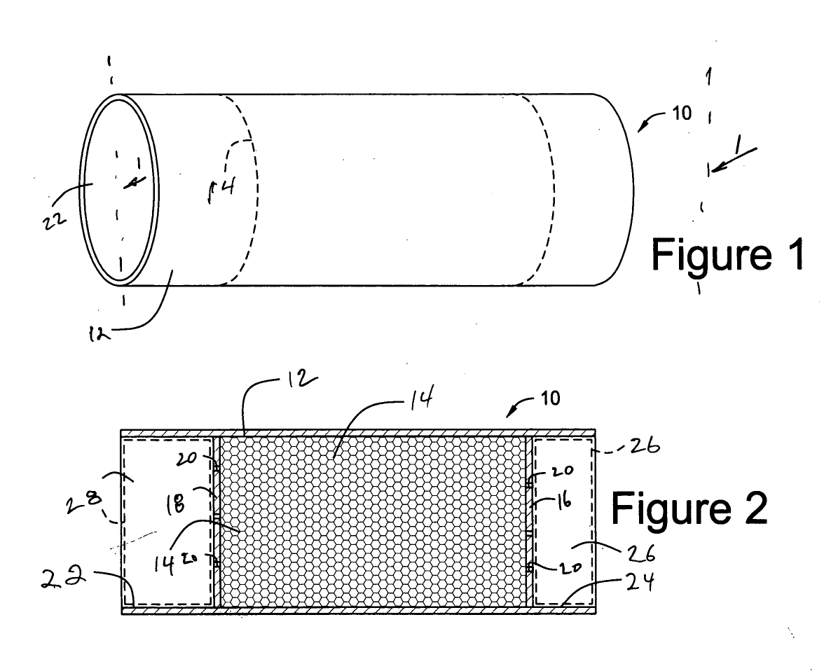

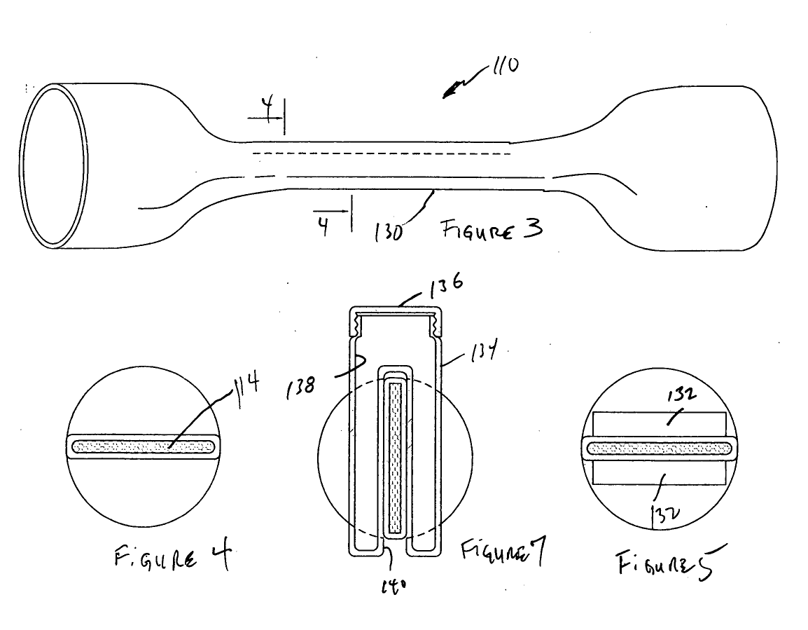

An alternative collection cartridge 110 is illustrated in FIG. 3. Generally the construction of cartridge 110 is similar to that of the cartridge of FIG. 1, except that the central area 130 is of a relatively flattened configuration in order to promote the cooling of collection members 114, as is illustrated in FIG. 4.

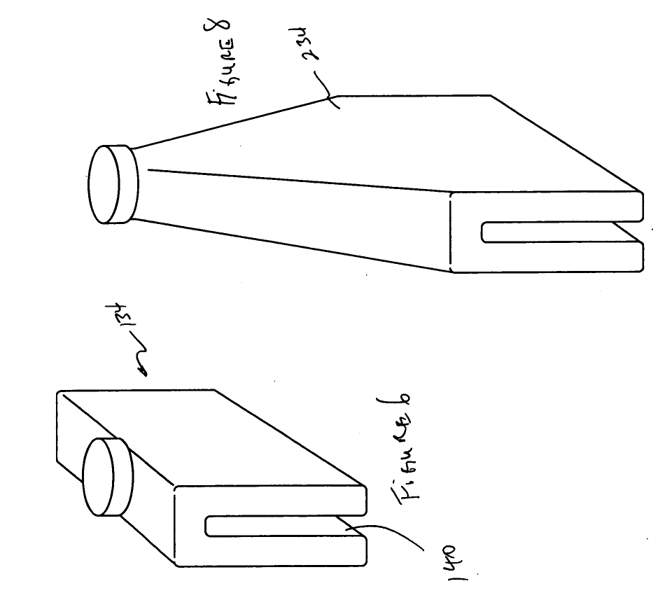

Such cooling may be achieved using something as simple as a bag of ice water, dry ice, or the like. Alternatively, referring to FIG. 5, an electrothermal cooling device 132 may be used to provide the desired degree of cooling. Still another alternative cooling device is a bottle filled with a coolant, such as cold water, powdered dry ice, or the like. Such a bottle 134 is illustrated in FIG. 6. As illustrated in FIG. 7, bottle 134 has a cap 136 allowing the inside 138 to be filled with a cooling material. Bottle 134, after it is filled with a coolant, such as powdered dry ice, is sealed with cap 136. Bottle 134 defines a central space 140 which may be slid over central portion 130 of cartridge 110. Such an arrangement is shown in FIG. 7.

FIG. 8 illustrates an alternative bottle 234 having an elongated neck which may be easier to fill with material and which also has a higher capacity for cooling a scent collection cartridge because of its increased volume.

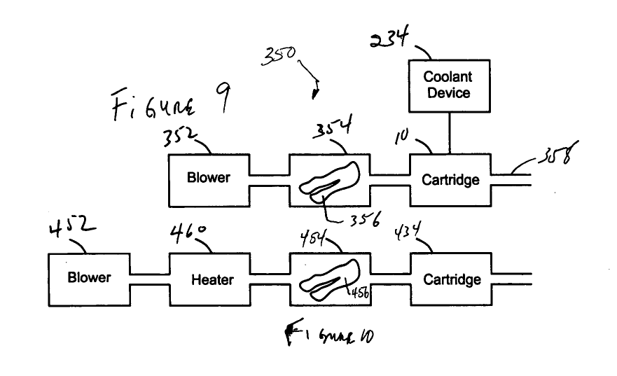

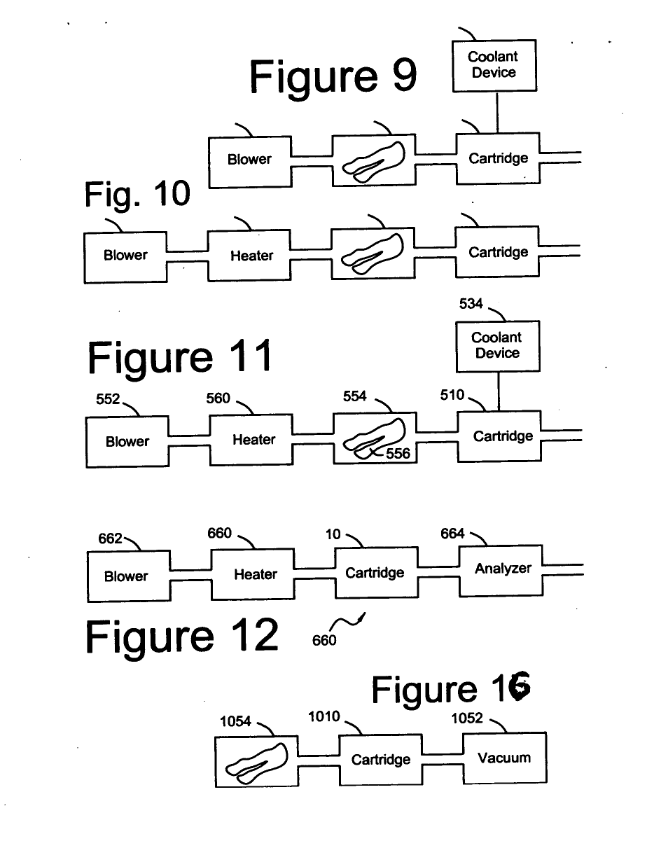

An apparatus 350 for collecting odiferous material in accordance with the invention is illustrated in schematic form in FIG. 9. In accordance with the invention, a blower 352 exhausts air into a chamber 350 which contains a scent bearing item, such as a garment 356. Air which passes over garment 356 draws away odiferous materials which are driven into a cartridge, such as cartridge 10 which is cooled by a coolant device, such as bottle 234. They air, stripped of these odiferous materials, is then exhausted through an output duct 358. After the operation has been completed, cartridge 10 is put in an air tight envelope, as described above.

An alternative arrangement is illustrated in FIG. 10. In this arrangement, the output of blower 452 is heated by heater 460. Thus, the air circulating around and passing through garment 456 is heated and this results in a greater removal of odiferous materials from the garment located in chamber 454. The air exiting chamber 454 is then driven into cartridge 434, where odiferous material is collected.

Referring to FIG. 11, an arrangement incorporating the advantages of the arrangements of FIG. 9 and FIG. 10 is illustrated. In this arrangement, the output of blower 552 is heated by heater 560. Thus, the air circulating around garment 556 is heated and this results in a greater removal of odiferous materials from the garment located in chamber 554. The air exiting chamber 554 is then driven into cartridge 510, where odiferous material is collected. Cartridge 510 is cooled by a coolant device 534. After the operation has been completed, cartridge 510 is put in an air tight envelope, as described above.

Referring to FIG. 12, when it is decided to analyze the odiferous material saved in a cartridge fabricated in accordance with the present invention and loaded with odiferous material in accordance with the present invention, a cartridge, such as cartridge 10, is placed in a system 660 such as that illustrated in FIG. 12. System 660 comprises a blower 662. Blower 662 blows air into a heater 660, resulting in the introduction of warm air into cartridge 10. The use of warm air in cartridge 10 results in a greater release of odiferous material in a relatively short period of time resulting in a relatively sensitive detection of odiferous material by an analytic device 664, such as a GC head space mass spectrometer.

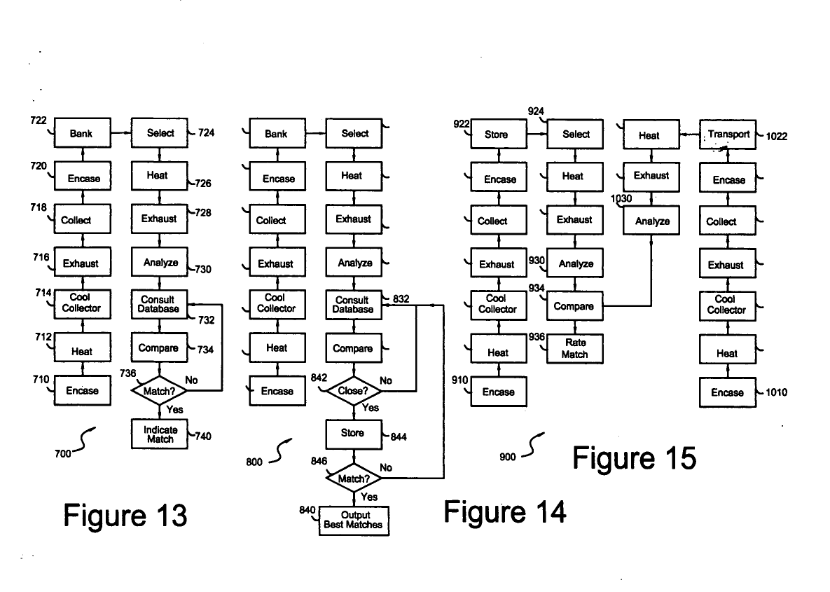

The methodology of the present invention is illustrated in FIG. 13. In accordance with this embodiment of the invention, a method 700 begins with the step 710 of encasing an item of evidence such as a garment in an airtight plastic bag. The air in the plastic bag is heated at step 712. A cartridge, such as cartridge 10, is then cooled at step 714. Air is then driven through the garment at step 716 and the exhaust is collected on collector 10 at step 718. The loaded collector 10 is then put in a sealed plastic bag at step 720 and deposited in a bank at step 722. At an appropriate time, the loaded collector 10 is selected at step 724 and heated at step 726 in an apparatus such as that illustrated in FIG. 12. At the same time, hot air is passed through collector cartridge 10 and the exhaust collected at step 728. At step 730 the exhaust is passed to an analyzer which produces a fingerprint of the odiferous materials, volatiles and the like previously collected in collector cartridge 10 and released during step 728. At step 730 the analysis is sent to a database of odiferous data which is consulted to determine whether there is any match during a comparison step 734. If there is a match, at step 736, an indication is made, or a rating of the match is given. If a match or close match is not found, the system returns to the database to make a comparison with other fingerprints stored in the database. Alternatively, all fingerprints in the database may be compared and the top matches indicated at step 740.

An alternative process is illustrated in FIG. 14. However, in this method 800, close comparison is assessed at step 842, and if there is not a finding within preset ranges, the system returns to consult the database at step 832. If the degree of closeness is within the preset ranges, the information with respect to the database entry is stored at step 844. If the degree of closeness is strong enough to result in the finding of a match, this is determined at step 846 and the output provided at step 840. If the sample does not qualify as a scent match to a scent in the database, the system returns at step 846 to step 832, where the database is again consulted. When all entries in the database have been consulted, the system evaluates results and outputs the best matches at step 840. Such output takes the form of a list of candidates with decreasing scores, where the score is proportional to the exactness of the matching.

In many cases, and odors is taken from a crime scene and have information which one would like to preserve until more evidence is found. The options are to create an electronic record on the scent and put it into a database for later identification as in the methods of the FIGS. 13 and 14. Alternatively, one may choose to simply preserve a collector cartridge with a particular scent until a later piece of evidence is found to which it can be compared. In the second case, two collectors would be heated simultaneously and compared.

In accordance with this method 900, an item of evidence is encased at step 910, treated as in the method of FIG. 13 and stored at step 922. When an item of evidence is discovered at a later time, it is encased at step 1010, processed as in the method of FIG. 13, and transported at step 1022.

The collector cartridge containing the later discovered evidence is then heated, and heated air is blown through it for analysis at step 1030. Likewise, the stored sample is selected at step 924, heated and subjected to a flow of heated air and the exhaust collected and analyzed at step 930, in much the same manner as the method of FIG. 13. The two analyses are then compared to each other at step 934 and the degree of match then noted for presentation as evidence, for example by an expert in a court hearing at step 936.

If desired, multiple samples may be taken at a crime scene, or even from a single garment by cutting the garment into two or more pieces, and when an identification is made with a forensic instrument, dogs may be used to make a collaborating identification.

Referring to FIG. 16, still yet another alternative embodiment of the inventive apparatus for collecting scent is illustrated. In accordance with this embodiment, a sample of clothing is placed in a bag 1054. A cartridge 1010 is connected to receive air from bag 1054. The system is completed by a vacuum source 1052 which is activated after clothing has been put in bag 1054 and cartridge 1010 inserted in line. The result is to draw air containing scent through cartridge 1010. In accordance with the preferred embodiment, the system of FIG. 17 may be modified through the use of a coolant device as illustrated in FIG. 9, for the purpose of cooling collector cartridge 1010. Alternatively or in addition, means may be provided for heating the contents of bag 1054 to induce the outflow of more odiferous material. In accordance with a preferred embodiment of the invention, it is anticipated that the inventive system will include a charcoal scent collecting filter. Before being used, the filter is treated in a baking or out gassing operation to ensure that the charcoal is free of any contaminating scent from handling, manufacturing or any other processes through which it has been. The treated charcoal filter is sealed in a plastic bag and only opened when it is being used at the crime scene or when it is being used in the lab.

In accordance with the invention, it is not necessary that such a charcoal filter, or any filter be cooled. Likewise, it is not necessary that samples of material bearing scents, such as clothing, be heated.

It is also noted that accordance with the present invention a collection cartridge, for example any charcoal or zeolite collection filter may be simply left in a room where a crime has been committed and scents allowed to be absorbed into it. Another option in accordance with the present invention is to blow air from the crime scene through a collector. For example, the room where the crime has been committed may be sealed and a scent collection cartridge placed in the room with a blower to blow air through it.

It is particularly advantageous in accordance with the present invention to use scent collection materials, such as charcoal or zeolites which have pores in them and which have the capacity of collecting large amounts of scent.

It is also noted that in accordance with the present invention, specific scent-collection materials, such as charcoal or zeolites may be selected for their characteristic of being selective or effective with respect to the collection of various target scent material(s).

In addition, it is noted that any appropriate a device may be used for the purpose of measuring the characteristics of odiferous materials, as may be used in the art. However, it is believed that a GC head space mass spectroscopy instrument is most effective in quantitatively measuring a “scent fingerprint” given the relatively modest amounts of odiferous material typically found or collectible at a crime scene.

While an illustrative embodiment of the invention has been described, it is, of course, understood that various modifications may be made by those of ordinary skill in the art. Such modifications are within the spirit and scope of the invention, which is limited and defined only by the appended claims.

1 . A scent collection method, comprising:
(a) putting an item bearing a sample of a scent to be identified in an enclosure;
(b) heating said item;
(c) introducing a quantity of air into said enclosure;
(d) withdrawing the air from said enclosure after said item has been heated; and
(e) passing said withdrawn air through a scent collection member to collect scent on said scent collection member.

2. A scent collection and output method as in claim 1, further comprising:
(f) cooling said scent collection member; and
(g) sealing said scent collection member in an envelope.

3. A scent collection and output method as in claim 2, further comprising:
(h) removing said scent collection member from said envelope in which said scent collection member has been sealed;
(i) heating said scent collection member;
(j) passing air to said scent collection member; and
(k) using the air passed through said scent collection member as a stimulus in a scent identification procedure.

4. A scent collection and output method as in claim 3, wherein said procedure comprises using electronic instrumentation or trained animals to obtain information respecting said collected scent.

5. A scent collection and output method as in claim 1, wherein said item is sealed within said enclosure.

6. A scent collection and output method as in claim 5, wherein heating of said item is performed after said enclosure has been sealed, after an item of information has been uncovered relating to said sample.

7. A scent collection and output method as in claim 6, wherein said heating of said item is performed after a period of time greater than 15 minutes has elapsed.

8. A method of collecting scent from a smooth surface for forensic evaluation, comprising:
(a) wiping a scent collecting member over a portion of said smooth surface;
(b) enclosing said smooth surface in a scent-containing container containing air;
(c) heating said smooth surface with a sufficient degree of heat to release relatively volatile scent material into said air, while retaining less volatile material on said smooth surface; and
(d) driving said air through a collection member to collect in said collection member volatile scent material released into said air.

9. A method of collecting scent from a smooth surface for forensic evaluation as in claim 8, further comprising:
(e) cooling said collection member while driving said air through said collection member to collect in said collection member volatile scent material released into said air.

10. A scent collection method, comprising:
(a) putting an item bearing a sample of a scent to be identified in an enclosure;
(b) introducing a quantity of air into said enclosure;
(c) withdrawing the air from said enclosure;
(e) passing said withdrawn air through a scent collection member to collect scent on said scent collection member; and
(f) cooling said scent collection member while said air is passing through said scent collection member.

11. A scent collection and output method as in claim 10, further comprising:
(g) sealing said scent collection member in an envelope.

12. A scent collection and output method as in claim 10, further comprising:
(g) removing said scent collection member from said envelope in which said scent collection member has been sealed;
(h) heating said scent collection member;
(i) passing air to said scent collection member; and
(j) using the air passed through said scent collection member as a stimulus in a scent identification procedure.

13. A scent collection method, comprising:
(a) putting an item bearing a sample of a scent to be identified in an enclosure;
(b) introducing a quantity of air into said enclosure;
(c) withdrawing the air from said enclosure;
(d) passing said withdrawn air through a scent collection member to collect scent on said scent collection member;
(e) heating said scent collection member;
(f) passing air through said scent collection member; and
(g) using the air passed through said scent collection member as a stimulus in a scent identification procedure.

14. A scent collection method as in claim 13, wherein said scent collection member is heated by heating said air passing through said scent collection member prior to said air passing through said scent collection member.

15. A scent collection apparatus, comprising:
(a) an enclosure for receiving an item bearing a sample of a scent to be identified;
(b) a first heater for increasing the temperature of said item;
(c) an air blower having an output and having an input, said input being coupled to withdrawn air from said enclosure containing said item; and
(d) a scent collection member coupled to receive the output of said air blower, whereby odiferous materials entrained within said air output by said blower are caused to accumulate on said scent collection member.

16. A scent collection and output apparatus as in claim 15, further comprising:
(e) a cooling member thermally coupled to said scent collection member.

17. A scent collection and output apparatus as in claim 16, further comprising:
(f) a second heater coupled to said scent collection member;
(g) a second air blower coupled to drive air to said scent collection member; and
(h) a conduit for passing air passed through said scent collection member to and output port for use as a stimulus in a scent identification procedure.

18. Apparatus as in claim 15, wherein said scent collection member comprises a zeolite.

19. Apparatus as in claim 15, wherein said scent collection member comprises activated charcoal.

20. Apparatus as in claim 15, wherein said blower comprises a fan for driving air through said Planck.

21. Apparatus as in claim 16, wherein said cooling member comprises a Pelletier cell.

22. Apparatus as in claim 15, wherein said first heater comprises an electrochemical heat releasing cartridge.

23. Apparatus as in claim 16, wherein said cooling member comprises an electrochemical cooling cartridge.

24. Apparatus as in claim 17, wherein said second heater comprises an electrical heater.

25. Apparatus as in claim 15, wherein said cooling member comprises a refrigerant based cooler.

26. A scent collection method, comprising:
(a) putting an item bearing a sample of a scent to be identified in an enclosure;
(b) introducing a quantity of air into said enclosure;
(c) withdrawing the air from said enclosure;
(d) passing said withdrawn air through a scent collection member to collect scent on said scent collection member; and
(e) cooling said scent collection member while said air is passing through said scent collection member.

27. A scent collection and output method as in claim 26, further comprising:
(j) sealing said scent collection member in an envelope.

28. A scent collection and output method as in claim 27, further comprising:
(g) removing said scent collection member from said envelope in which said scent collection member has been sealed;
(h) heating said scent collection member;
(i) passing air to said scent collection member; and
(j) using the air passed through said scent collection member as a stimulus in a scent identification procedure.

29. A scent collection apparatus, comprising:
(a) putting an item bearing a sample of a scent to be identified in an enclosure;
(b) introducing a quantity of air into said enclosure;
(c) withdrawing the air from said enclosure;
(d) passing said withdrawn air through a scent collection member to collect scent on said scent collection member;
(e) heating said scent collection member;
(f) passing air through said scent collection member; and
(g) using the air passed through said scent collection member as a stimulus in a scent identification procedure.

30. A scent collection method as in claim 29, wherein said scent collection member is heated by heating said air passing through said scent collection member prior to said air passing through said scent collection member.

31. A scent collection method, comprising:
(a) putting an item bearing a sample of a scent to be identified in an enclosure;
(b) allowing the introduction of a quantity of air into said enclosure;
(c) introducing a quantity of air into said enclosure;
(d) withdrawing the air from said enclosure after said item has been heated using a vacuum source; and
(e) passing said withdrawn air through a scent collection member to collect scent on said scent collection member prior to introduction of said air into said vacuum source.

32. A scent collection method, comprising:
(a) putting an item bearing a sample of a scent to be identified in a place where scents may be collected;
(b) withdrawing the air from said enclosure after said item has been heated; and
(c) passing said withdrawn air through a scent collection member to collect scent on said scent collection member, said scent collection member having pores which allow the collection of odiferous material.

33. A scent collection method as in claim 33, wherein said scent collection member comprises charcoal.

34. A scent collection member, comprising a porous material.

35. A scent collection member as in claim 34 wherein said porous material is charcoal.

36. a scent collection member as in claim 34 wherein said porous material is a zeolite.
